(19) United States
(12) Patent Application Publication
(10) Pub. No.: US 2013/0295882 A1
(43) Pub. Date: Nov. 7, 2013

(54) SYSTEM, SERVER AND METHOD FOR INVALIDATING A PASSWORD REMEMBERED BY AN APPLICATION ASSOCIATED WITH A MOBILE TERMINAL

(71) Applicant: Dong Zhao, Shenzhen (CN)

(72) Inventor: Dong Zhao, Shenzhen (CN)

(73) Assignee: TENCENT TECHNOLOGY (SHENZHEN) COMPANY LIMITED, Shenzhen, Guangdong (CN)

(21) Appl. No.: 13/881,349

(22) PCT Filed: Dec. 23, 2011
(86) PCT No.: PCT/CN11/84544

§ 371 Date: Apr. 24, 2013

(30) Foreign Application Priority Data
Jan. 27, 2011 (CN) 201110032534.9

(51) Int. Cl. H04W 12/06

(52) U.S. Cl. CPC H04W 12/06
USPC 455/411

(57) ABSTRACT

Examples of the present invention disclose a system, application server and method for invalidating a password remembered by an application associated with the mobile terminal. The method includes: providing an corresponding application according to a download request of a mobile terminal, wherein an option of authentication information used for invalidating a password remembered by the application associated with the mobile terminal is configured in the provided application; receiving a register request sent from the mobile terminal; storing authentication information configured by a user through the mobile terminal and used for invalidating the password remembered by the application associated with the mobile terminal; and receiving an invalidation request sent from the user; obtaining the stored authentication information corresponding to the user account carried in the invalidation request to authenticating the user; and outputting an instruction for invalidating the password remembered by the application to the mobile terminal to which the user account belongs to cause the mobile terminal to invalidate the password remembered by the associated application and corresponding to the user account carried in the instruction after the authentication is passed. By applying the examples of the present invention, the invalidation cost is reduced.

### CROSS-REFERENCE TO RELATED APPLICATIONS

This application is a 371 U.S. National Stage of International Application No. PCT/CN2011/084544, filed Dec. 23, 2011, which claims priority to Chinese Patent Application No. 201110032534.9, filed Jan. 27, 2011. The disclosures of the above applications are incorporated herein by reference.

### FIELD OF THE INVENTION

The present invention relates to information security technology, more particularly, to a system, server and method for invalidating a password remembered by an application associated with a mobile terminal.

### BACKGROUND OF THE INVENTION

With the development of mobile communication technology, network communication performed by a mobile terminal is more and more popular. A user accesses a wireless network through a mobile terminal, and obtains information from the network, e.g., downloading network applications, performing on-line entertainments. For example, through installing a corresponding application in the mobile terminal, the user may perform mobile phone QQ chat, mobile phone QQ Landlords, or mobile phone micro-blog, etc.

After the corresponding application is installed in an existing mobile terminal such as an iPhone, an iPad, a mobile phone with Android, or a mobile phone with WM7, in order to protect user's legitimate rights and interests, when a user logs into an account through the mobile terminal, the user is required to provide the account and the password to authenticate the user who access a wireless network through the mobile terminal. Since the user needs to enter the account name and the password with each login, the user's operation is complicated, the time required by the login is long, and user experience is affected. Therefore, in login functionalities of a large number of applications, when a user logs into the account, a subsidiary functionality of “remember the password” is provided to the user, i.e., an optional subsidiary functionality that the account and the password of the user is recorded automatically through a software manner is provided to the user to relieve the user from entering the account and the password again in a subsequent login. Thus, the user may perform rapid and automatic login subsequently, so that the user's operation is simplified.

FIG. 1 is a schematic diagram illustrating a typical login interface for an application associated with a mobile terminal to remember a password in the prior art. As shown in FIG. 1, in the prior art, a main method for an associated application to remember a password is that the “remember the password” information provided by a login interface showed by an application is selected when a user logs in firstly, and the account and password used for logging in are saved after the login succeeds; when the user runs the application again through the mobile terminal, the application automatically obtains the saved account and password for automatic login.

The existing method for configuring an application associated with a mobile terminal to remember a password is easy to cause a security problem. That is, if the mobile terminal is lost or lent, the application account and the password of an original user are still saved in the mobile terminal. If the original user configures the subsidiary functionality of “remember the password” during a login process, a current owner of the mobile terminal can easily login using the subsidiary functionality of “remember the password” of the application in the mobile terminal, therefore, the privacy of the original user is disclosed or a dispute of a paid content is caused.

Therefore, in order to avoid the disclosure of the original user's privacy or the dispute of the paid content, once confirming that the mobile terminal is lost, the original user logs into a server of an application provider to which the application belongs through another mobile terminal, and completes the operation of changing the password or canceling the account of the application to invalidate the password remembered by the application associated with the mobile terminal. If the password remembered by the application associated with the mobile terminal is invalidated through cancelling the account of the application, previous recorded information related to the application will be lost, therefore, great inconvenience is caused to the user, the invalidation cost is high and the invalidation speed is slow. If the password remembered by the application associated with the mobile terminal is invalidated by changing the password through the mobile terminal, since the password is changed frequently, when the application associated with the mobile terminal remembers the password once again, it is easy for the user to forget the changed password, so that the user may not login, thus, the invalidation cost is high, the social and economic benefits are low.

### SUMMARY OF THE INVENTION

In view of the above description, a main objective of the present invention is to provide a system for invalidating a password remembered by an application associated with a mobile terminal, so as to reduce the invalidation cost.

Another objective of the present invention is to provide an application server for invalidating a password remembered by an application associated with a mobile terminal, so as to reduce the invalidation cost.

Still another objective of the present invention is to provide a method for invalidating a password remembered by an application associated with a mobile terminal, so as to reduce the invalidation cost.

In order to achieve the above objectives, an example of the present invention provides a system for invalidating a password remembered by an application associated with a mobile terminal. The system includes a mobile terminal, an application server and a telephone call server, wherein

the mobile terminal is adapted to register to the application server through an installed application; store a configured user account and a configured registered password; configure authentication information used for invalidating the password remembered by the application associated with the mobile terminal; receive an instruction for invalidating the password remembered by the application associated with the mobile terminal sent from the application server to invalidate the password remembered by the associated application and corresponding to the user account carried in the instruction;

the application server is adapted to provide the application to the mobile terminal, wherein an option of the authentication information used for invalidating the password remembered by the application associated with the mobile terminal is configured in the provided application; store the user account and the password of the application as well as the authentication information configured by a user through the mobile terminal and used for invalidating the password remembered by the application associated with the mobile terminal; receive a request for obtaining authentication information sent from the telephone call server; return to the telephone call server the authentication information corresponding to the user account carried in the request for obtaining authentication information; receive authentication success information sent from the telephone call server and output the instruction for invaliding the password remembered by the application associated with the mobile terminal to the mobile terminal; and

the telephone call server is adapted to receive an invalidation request sent from the user; transmit to the application server the request for obtaining authentication information according to the user account carried in the invalidation request; authenticate the user according to the returned authentication information; transmit to the application server the authentication success information after the authentication is passed.

An example of the present invention provides a system for invalidating a password remembered by an application associated with a mobile terminal. The system includes a mobile terminal, an application server, wherein

the mobile terminal is adapted to register to the application server through an installed application; store a configured user account and a configured registered password; configure authentication information used for invalidating the password remembered by the application associated with the mobile terminal; receive an instruction for invalidating the password remembered by the application associated with the mobile terminal sent from the application server to invalidate the password remembered by the associated application and corresponding to the user account carried in the instruction; and

the application server is adapted to provide the application to the mobile terminal, wherein an option of the authentication information used for invalidating the password remembered by the application associated with the mobile terminal is configured in the provided application; store the user account and the password of the application as well as the authentication information configured by a user through the mobile terminal and used for invalidating the password remembered by the application associated with the mobile terminal; receive an invalidation request sent from the user; obtain the stored authentication information corresponding to the user account carried in the invalidation request to authenticate the user; and output the instruction for invaliding the password remembered by the application associated with the mobile terminal to the mobile terminal after the authentication is passed.

An example of the present invention provides an application serve including an application managing module, a registration managing module, a registration information storing module and an invalidation authenticating module, wherein

the application managing module is adapted to provide an application to a mobile terminal, wherein an option of authentication information used for invalidating a password remembered by the application associated with the mobile terminal is configured in the provided application;

the registration management module is adapted to interact with the mobile terminal; perform registration; after the user registers, output a user account and the password of the application as well as the authentication information configured by a user through the mobile terminal and used for invalidating the password remembered by the application associated with the mobile terminal to the registration information storing module;

the registration information storing module is adapted to store the received information; and

the invalidation authenticating module is adapted to receive an invalidation request sent from the user; obtain the authentication information corresponding to the user account carried in the invalidation request from authentication information stored in the registration information storing module to authenticate the user; and output an instruction for invalidating the password remembered by the application associated with the mobile terminal to a mobile terminal after the authentication is passed.

An example of the present invention provides a method for invalidating a password remembered by an application associated with a mobile terminal, including:

providing an corresponding application according to a download request of a mobile terminal, wherein an option of authentication information used for invalidating a password remembered by the application associated with the mobile terminal is configured in the provided application;

receiving a register request sent from the mobile terminal; storing authentication information configured by a user through the mobile terminal and used for invalidating the password remembered by the application associated with the mobile terminal; and

receiving an invalidation request sent from the user; obtaining the stored authentication information corresponding to a user account carried in the invalidation request to authenticate the user; and outputting an instruction for invalidating the password remembered by the application to the mobile terminal to cause the mobile terminal to invalidate the password remembered by the associated application and corresponding to the user account carried in the instruction after the authentication is passed.

It can be seen from the above description that in the system, server and method for invalidating the password remembered by the application associated with the mobile terminal according to the examples of the present invention, the mobile terminal registers to the application server through the installed application; stores the configured user account and information about the configured registered password; configures the authentication information used for invalidating the password remembered by the application associated with the mobile terminal; receives the instruction for invalidating the password remembered by the application associated with the mobile terminal sent by the application server to invalidate the password remembered by the associated application and corresponding to the user account carried in the instruction; the application server provides the application to the mobile terminal; configures the option of the authentication information used for invalidating the password remembered by the application associated with the mobile terminal in the provided application; stores the user account and the information about the registered password of the registered application in the mobile terminal as well as the authentication information which is configured by the user through the mobile terminal and is used for invalidating the password remembered by the application associated with the mobile terminal; receives a request for obtaining authentication information sent from the telephone call server; returns to the telephone call server the authentication information corresponding to the user account carried in the request for obtaining authentication information; receives authentication success information sent from the telephone call server, outputs the instruction for invaliding the password remembered by the application associated with the mobile terminal to the mobile terminal to which the user account belongs; the telephone call server receives an invalidation request sent from the user; transmits to the application server the request for obtaining authentication information according to the user account carried in the invalidation request; authenticate the user according to the returned authentication information; transmit to the application server the authentication success information after the authentication is passed. In this way, through coordination of the application server, the telephone call server and the application of the mobile terminal, the user may configure a specific password for invalidating or terminating the login of an account of the user through the application in the mobile terminal, therefore, the invalidation cost of the user is effectively reduced.

### BRIEF DESCRIPTION OF DRAWINGS

FIG. 1 is a schematic diagram illustrating a typical login interface for an application associated with a mobile terminal to remember a password in the prior art.

FIG. 2 is a schematic diagram illustrating a structure of a system for invalidating a password remembered by an application associated with a mobile terminal according to an example of the present invention.

FIG. 3 is a schematic diagram illustrating a structure of an application server according to an example of the present invention.

FIG. 4 is a schematic diagram illustrating another structure of a system for invalidating a password remembered by an application associated with a mobile terminal according to an example of the present invention.

FIG. 5 is a flowchart illustrating a method for invalidating a password remembered by an application associated with a mobile terminal according to an example of the present invention.

FIG. 6 is a flowchart illustrating a method for invalidating a password remembered by an application associated with a mobile terminal according to an example of the present invention.

FIG. 7 is a flowchart illustrating a method for invalidating a password remembered by an application associated with a mobile terminal according to an example of the present invention.

### DETAILED DESCRIPTION OF THE INVENTION

Examples of the present invention are hereinafter described in detail with reference to accompanying drawings and examples, so as to make the objective, technical solution and merits of the examples of the present invention more apparent.

In the prior art, if a mobile terminal is lost, a password remembered by an application associated with the mobile terminal can only be invalidated through changing the password or canceling the account of the application, which causes great inconvenience to a user, and the invalidation cost is high. In examples of the present invention, when the user registers an application and configures a user account and information about a registered password in an application server, the user further configures information about an invalidation password used for invalidating the password remembered by the application associated with the mobile terminal. When the mobile terminal is lost, an invalidation request is sent to the application server through another mobile terminal or another communication manner. The application server performs invalidation processing to the password remembered by the associated application of the user account according to the user account and the information about the invalidation password inputted by the user, thus, it is not necessary to change the password or cancel the account of the application.

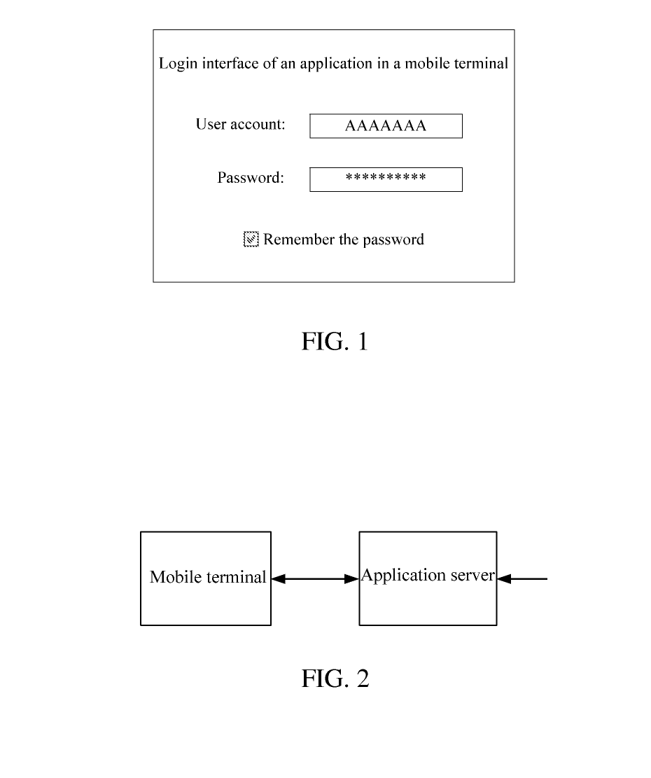

FIG. 2 is a schematic diagram illustrating a structure of a system for invalidating a password remembered by an application associated with a mobile terminal according to an example of the present invention. As shown in FIG. 2, the system includes a mobile terminal and an application server, wherein the mobile terminal is adapted to register to the application server through an installed application, store a configured user account and information about a registered password, configure authentication information used for invalidating the password remembered by the application associated with the mobile terminal, receive an instruction for invalidating the password remembered by the application associated with the mobile terminal sent by the application server to invalidate the password remembered by the associated application and corresponding to the user account carried in the instruction.

In the example, the mobile terminal downloads the application from the application server and installs the application, registers to the application server, configures and stores the user account and the information about the registered password, which are the same as the prior art, and may be found from relative technical documents, and are not described here repeatedly. The difference between the example of the present invention and the prior art is that during a process of registering to the application server, the authentication information used for invalidating the password remembered by the application associated with the mobile terminal may be configured. The authentication information may include information about the user account and the invalidation password. When the information about the invalidation password is configured in a current user account, the invalidation password is bound to the current user account by default. The authentication information corresponds to the invalidation of one password remembered by the associated application. In practice, one user account may be associated with multiple applications. For example, a QQ account may be used as the user account for applications such as mobile phone QQ chat, mobile phone QQ Landlords or mobile phone micro-blog, etc. Thus, after the invalidation password used for invalidating is configured for the user account, if passwords remembered by the associated applications of the user account need to be invalidated, the passwords remembered by multiple applications associated with the user account are invalidated. Meanwhile, unified authentication information may be configured for the passwords remembered by all of the applications associated with the mobile terminal. The authentication information may include the information about the invalidation password only. Certainly, in order to improve the security of the authentication, the authentication information may include a virtual user account configured by the user and the information about the invalidation password.

After the instruction for invalidating the password remembered by the application associated with the mobile terminal is received, according to the user account carried in the instruction, the password remembered by the associated application corresponding to the user account is invalidated. In the instruction for invalidating the password remembered by the application associated with the mobile terminal, the number of the associated application to be invalidated is one or more than one. For example, if the user account is associated with one application, the password remembered by the associated application is invalidated; if the user account is associated with multiple applications, the passwords remembered by the multiple associated applications are invalidated; and if the user account is a virtual user account, the passwords remembered by all of the associated applications in the mobile terminal are invalidated. Thus, when detecting that the user logs in through the password remembered by the associated application, the mobile terminal directly refuses the request of the user, or prompts the user that the password remembered by the associated application has been invalidated already and requests the user to re-enter the user account and the registered password.

The application server is adapted to provide an application to the mobile terminal, wherein an option of the authentication information used for invalidating the password remembered by the application associated with the mobile terminal is configured in the provided application; store the user account and the information about the registered password of the registered application in the mobile terminal as well as the authentication information which is configured by the user through the mobile terminal and is used for invalidating the password remembered by the application associated with the mobile terminal; receive an invalidation request of the user; according to the user account carried in the invalidation request, obtain the stored authentication information corresponding to the user account to authenticate the user; after the authentication is passed, output the instruction for invaliding the password remembered by the application associated with the mobile terminal to the mobile terminal to which the user account belongs.

In the example, when a mobile terminal in which the user's associated application remembers the password is lost, the invalidation request is transmitted to the application server through another mobile terminal or a fixed telephone, the user account and the information about the invalidation password corresponding to the application needing to be invalidated are inputted. The application server obtains the stored corresponding authentication information according to the user account carried in the invalidation request, and authenticates the information about the invalidation password inputted by the user to determine whether it is necessary to perform the invalidation processing.

In practice, when obtaining the lost mobile terminal, the user may activate, through the application server, the password remembered by the application associated with the mobile terminal through a way which is the same as the method for invalidating the password remembered by the application associated with the mobile terminal, so that the mobile terminal may automatically login through the password remembered by the associated application again, therefore, the user can manage the consistence of the registered login information conveniently, and the inconvenience caused by frequently changing the user account and password by the user is reduced.

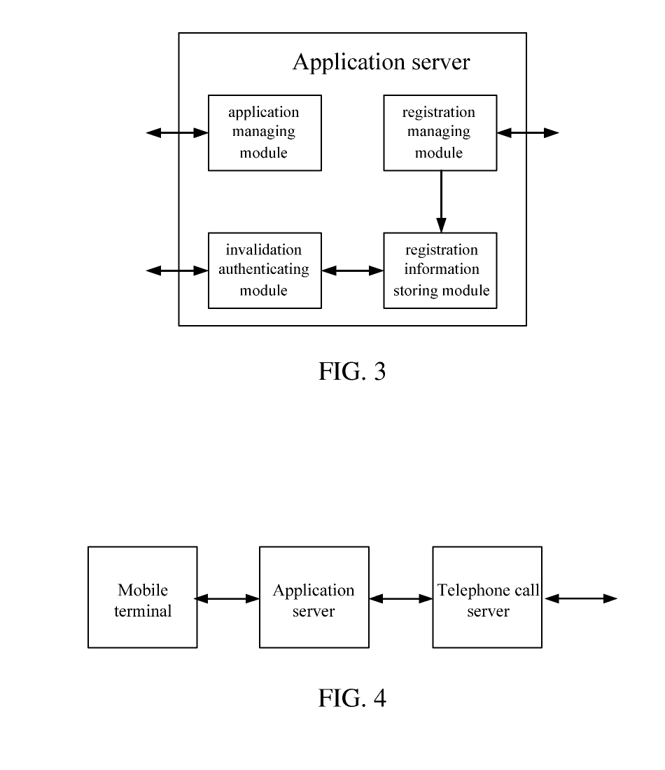

FIG. 3 is a schematic diagram illustrating a structure of an application server according to an example of the present invention. As shown in FIG. 3, the application server includes an application managing module, a registration managing module, a registration information storing module and an invalidation authenticating module.

The application managing module is adapted to provide an application to a mobile terminal, wherein an option of authentication information used for invalidating the password remembered by the application associated with the mobile terminal is configured in the provided application.

The registration managing module is adapted to interact with an external mobile terminal; perform registration; after the user registers, output a user account and information about a registered password of a registered application in the mobile terminal as well as the authentication information which is configured by the user through the mobile terminal and is used for invalidating the password remembered by the application associated with the mobile terminal to the registration information storing module.

The registration information storing module is adapted to store the received information.

In the example of the present invention, one user account corresponds to the information about two passwords: the registered password and the invalidation password; wherein the information about the registered password is used for the authentication when the user registers and logs in, and the information about the invalidation password is used for the authentication when the user invalidates the password remembered by the application associated with the mobile terminal. In practice, a user account may be bound to a number of a mobile terminal, or associated with the number of the mobile terminal.

The invalidation authenticating module is adapted to receive an invalidation request of the user; according to a user account carried in the invalidation request, obtain the authentication information corresponding to the user account from the authentication information stored in the registration information storing module; authenticate the user according to the obtained authentication information; after the authentication is passed, output an instruction for invalidating the password remembered by the application associated with the mobile terminal to the mobile terminal to which the user account belongs .

In practice, for a condition that the user transmits the invalidation request to the application server through a fixed telephone, the application server may transfer the authentication functionality to a telephone call server for performing.

FIG. 4 is a schematic diagram illustrating another structure of a system for invalidating a password remembered by an application associated with a mobile terminal according to an example of the present invention. As shown in FIG. 4, the system includes a mobile terminal, an application server and a telephone call server.

The structure and functionality of the mobile terminal are the same as those of the mobile terminal in FIG. 2, which are not described repeatedly here.

The application server is adapted to provide an application to the mobile terminal, wherein an option of the authentication information used for invalidating the password remembered by the application associated with the mobile terminal is configured in the provided application; store a user account and information about a registered password of a registered application in the mobile terminal as well as the authentication information which is configured by a user through the mobile terminal and is used for invalidating the password remembered by the application associated with the mobile terminal; receive a request for obtaining authentication information sent from the telephone call server; according to a user account carried in the request for obtaining authentication information, return the authentication information corresponding to the user account to the telephone call server; receive authentication success information sent from the telephone call server; output an instruction for invaliding the password remembered by the application associated with the mobile terminal to the mobile terminal to which the user account belongs.

The telephone call server is adapted to receive an invalidation request of the user; according to the user account carried in the invalidation request, transmit the request for obtaining authentication information to the application server; authenticate the user according to the returned authentication information; after the authentication is passed, transmit the authentication success information to the application server.

In the example of the present invention, the telephone call server may be an Interactive Voice Response (IVR) or an Automatic Speech Recognition (ASR). The user may initiate the invalidation request through a public phone box or a home fixed telephone, and input the corresponding information about the user account and the invalidation password according to a prompt of the telephone call server.

It can be seen from the above description that in the system for invalidating the password remembered by the application associated with the mobile terminal according to the example of the present invention, the mobile terminal registers to the application server through the installed application; stores the configured user account and information about the registered password; configures the authentication information used for invalidating the password remembered by the application associated with the mobile terminal; receives the instruction for invalidating the password remembered by the application associated with the mobile terminal sent by the application server; and invalidate the password remembered by the associated application and corresponding to the user account carried in the instruction. The application server provides the application to the mobile terminal; configures the option of the authentication information used for invalidating the password remembered by the application associated with the mobile terminal in the provided application; stores the user account and the information about the registered password of the registered application in the mobile terminal as well as the authentication information which is configured by the user through the mobile terminal and is used for invalidating the password remembered by the application associated with the mobile terminal; receives the invalidation request of the user; authenticates the user according to the stored authentication information; when the user logs in the application server through the mobile terminal next time, outputs the instruction for invalidating the password remembered by the application associated with the mobile terminal to the mobile terminal after the authentication is passed. In this way, through coordination of the application server and the application of the mobile terminal, the user may configure a specific password for invalidating or terminating the login of an account of the user through the application in the mobile terminal, thus, a technical solution for starting the invalidation capability through a shortcut is provided to the user. Therefore, a condition that the previous recorded information related to the user is lost due to the invalidation of the password remembered by the application associated with the mobile terminal through canceling the account of the application software is avoided, and another condition is also avoided in which the user performs the invalidation by changing the password through the mobile terminal, as the password is changed frequently, the user forgets the changed password and does not login. Therefore, the invalidation cost of the user is effectively reduced.

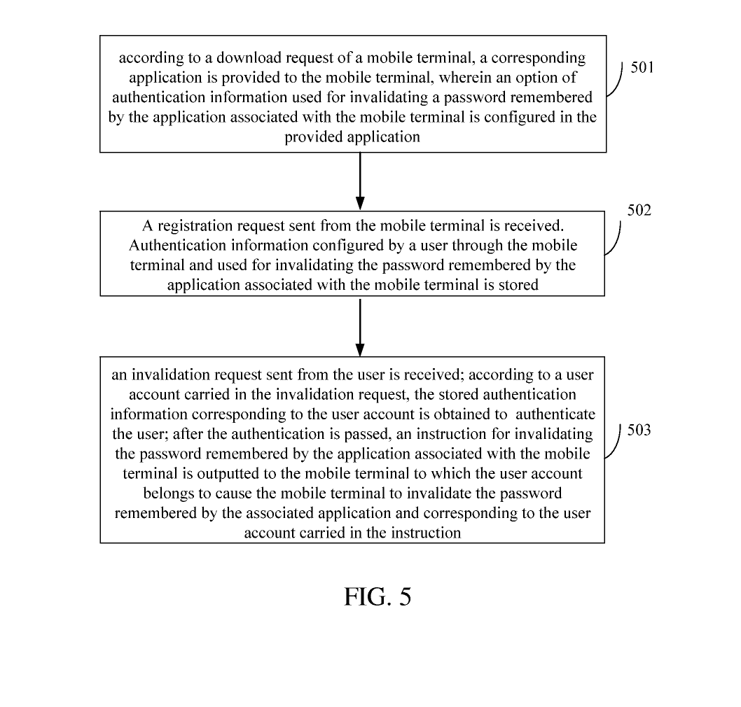

FIG. 5 is a flowchart illustrating a method for invalidating a password remembered by an application associated with a mobile terminal according to an example of the present invention. As shown in FIG. 5, the method includes operations as follows.

In block 501, according to a download request of a mobile terminal, a corresponding application is provided to the mobile terminal, wherein an option of authentication information used for invalidating a password remembered by the application associated with the mobile terminal is configured in the provided application.

In the present block, the authentication information includes information about a user account and an invalidation password.

In block 502, a registration request sent from the mobile terminal is received. Authentication information which is configured by a user through the mobile terminal and is used for invalidating the password remembered by the application associated with the mobile terminal is stored.

In the present block, the user registers to an application server through the mobile terminal. The application server assigns a user account for the user, and confirms the register password inputted by the user. At the same time, the authentication information used for invalidating the password remembered by the application associated with the mobile terminal is configured, e.g., the user account and the information about the invalidation password. After the registration succeeds, the application server returns registration success information to the mobile terminal. The mobile terminal stores the user account and the information about the registered password. When the application is loggined subsequently, if the user configures a subsidiary functionality of “remember the password” in a login interface of the application, the stored user account and the information about the registered password are obtained to simulate the user to input the user account and the registered password, and to request login to the application server at a network side.

In block 503, an invalidation request sent from the user is received; according to a user account carried in the invalidation request, the stored authentication information corresponding to the user account is obtained to authenticate the user; after the authentication is passed, an instruction for invalidating the password remembered by the application associated with the mobile terminal is outputted to the mobile terminal to which the user account belongs to cause the mobile terminal to invalidate the password remembered by the associated application and corresponding to the user account carried in the instruction.

In the present block, when a user's mobile terminal in which the associated application remembers the password is lost, the invalidation request may be transmitted to the application server through another mobile terminal or a fixed telephone. The user account and the configured invalidation password corresponding to the application needing to be invalidated are inputted. According to the stored authentication information, the application server authenticates the information inputted by the user. If the user account and the invalidation password inputted by the user are identical with the user account and the invalidation password included in the stored authentication information, the instruction for invalidating the password remembered by the application associated with the mobile terminal is outputted to the mobile terminal to which the user account carried in the invalidation request belongs.

Certainly, in practice, after the authentication is passed, a capability of the mobile terminal for logging into a service of the associated application through a terminal application may be terminated directly.

Two detailed examples are described hereinafter for further explanation.

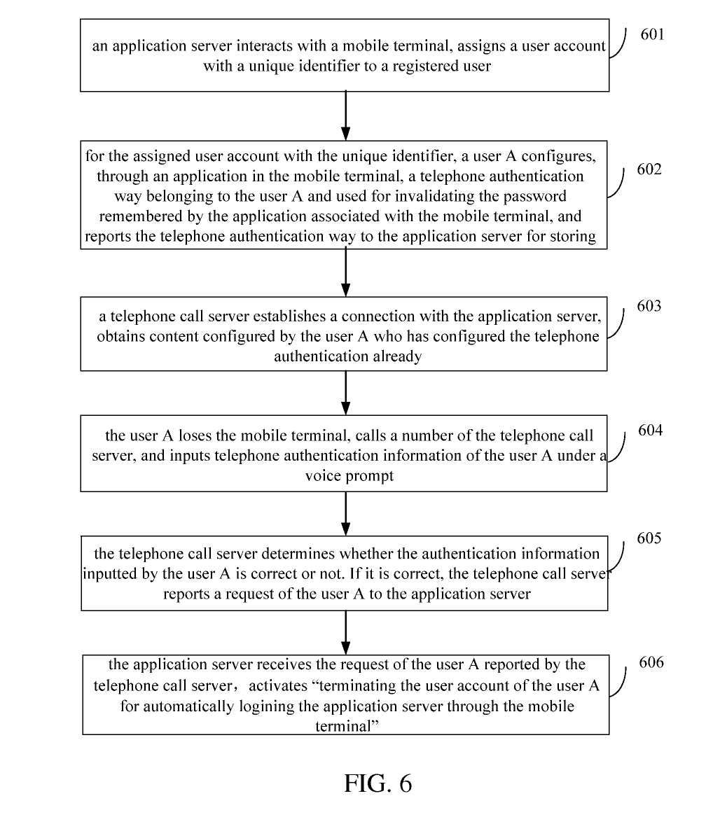

FIG. 6 is a flowchart illustrating a method for invalidating a password remembered by an application associated with a mobile terminal according to an example of the present invention. As shown in FIG. 6, the method includes operations as follows.

In block 601, an application server interacts with a mobile terminal, assigns a user account with a unique identifier to a registered user.

In block 602, for the assigned user account with the unique identifier, a user A configures, through an application in the mobile terminal, a telephone authentication way belonging to the user A and used for invalidating the password remembered by the application associated with the mobile terminal, and reports the telephone authentication way to the application server for storing.

In the present block, the user account and information about an invalidation password is configured through the telephone authentication way.

In block 603, a telephone call server establishes a connection with the application server, obtains content configured by the user A who has configured the telephone authentication already.

In block 604, the user A loses the mobile terminal, calls a number of the telephone call server, and inputs telephone authentication information of the user A under a voice prompt.

In the present block, when the mobile terminal with which the application associated remembers the password is not at the user A′s side, if the user A wants to terminate a functionality of automatic login possessed by the mobile terminal due to “remember the password”, the use A may immediately call the telephone number of the telephone call server through any telephone communication tools at the user A′s side, and input the telephone authentication information of the user A under the voice prompt.

In block 605, the telephone call server determines whether the authentication information inputted by the user A is correct or not. If it is correct, the telephone call server reports a request of the user A to the application server.

In block 606, the application server receives the request of the user A reported by the telephone call server, activates “terminating the user account of the user A for automatically logging into the application server through the mobile terminal”, and directly terminates a capability of the mobile terminal for logging into a service of the associated application through the terminal application.

In the present block, when the mobile terminal to which the user account belongs logs into the application server again using the user account and the password remembered by the associated application, the application server outputs an instruction for invalidating the password remembered by the application associated with the mobile terminal to the mobile terminal to which the user account belongs to invalidate the functionality of automatic login configured in the mobile terminal.

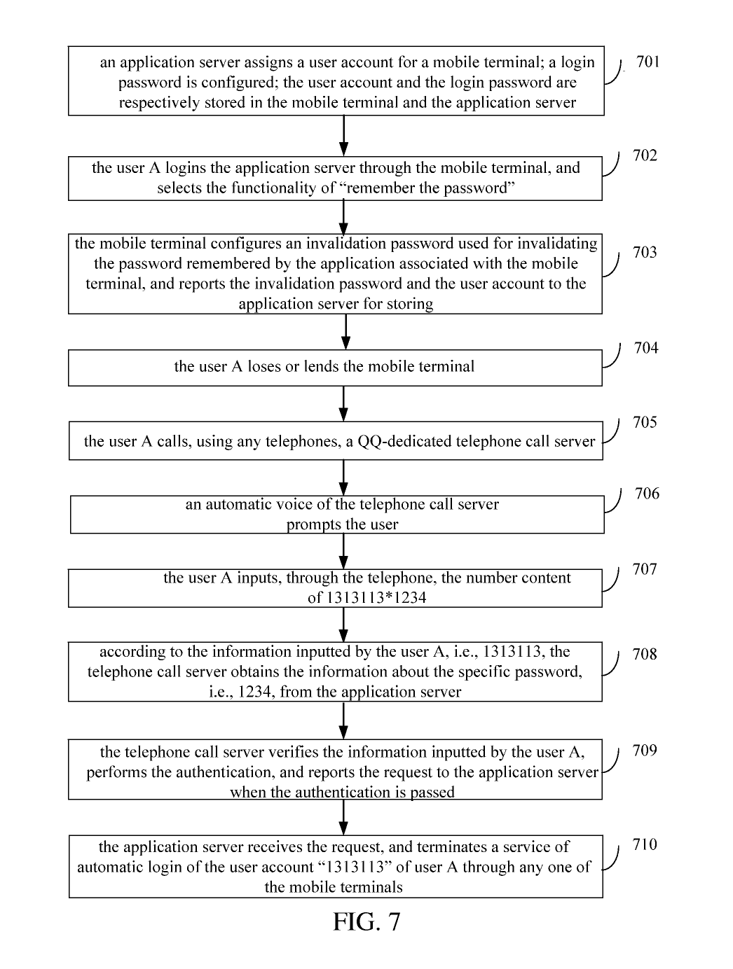

FIG. 7 is a flowchart illustrating a method for invalidating a password remembered by an application associated with a mobile terminal according to an example of the present invention. A QQ user is taken as an example, as shown in FIG. 7, the method includes operations as follows.

In block 701, an application server assigns a user account for a mobile terminal; a login password is configured; the user account and the login password are respectively stored in the mobile terminal and the application server.

In the present block, a user A has a digital user account 1313113 assigned by the QQ application server. The login password (i.e., the registered password) is ABCDEFGH.

The information of the user A, i.e., 1313113 and ABCDEFGH, is stored in the application server.

The information of the user A, i.e., 1313113 and ABCDEFGH, is stored in the mobile terminal through an encryption or a non-encryption way.

In block 702, the user A logs into the application server through the mobile terminal, and selects the functionality of “remember the password”.

In block 703, the mobile terminal configures an invalidation password used for invalidating the password remembered by the application associated with the mobile terminal, and reports the invalidation password and the user account to the application server for storing.

In the present block, the user A configures security information through the mobile terminal which the user A has logined, wherein “a specific password used for terminating the login capability of the mobile terminal through a telephone call server” is configured as 1234. The configured invalidation password is reported to the application server through the mobile terminal.

The application server stores the security information of the user A, i.e., 1313113*1234.

Certainly, in practice, the user may configure the security information through bearings of other mobile terminals. For example, the user may configure the security information by accessing a QQ service website through a webpage, or by a QQ application in a desktop computer.

In block 704, the user A loses or lends the mobile terminal.

In block 705, the user A calls, using any telephones, a QQ-dedicated telephone call server.

In the present block, the user A calls, using any telephones, a telephone number of the QQ-dedicated telephone call server, e.g., 4008800700.

The telephone call server provides an automatic voice service, which may tell and guide the user how to input the user account and the specific password when the user accesses through the telephone.

In practice, a Short Message Service (SMS) server may replace the telephone call. The user may send a short message to a pre-configured SMS service number to achieve an equivalent effect with the telephone call. For example, a short message with the content of “1313113*1234” is transmitted to “+1700110”. The telephone call server may also serve multiple different applications in a mobile terminal. For example, the QQ-dedicated telephone call server may provide security guarantee and invalidation processing for multiple applications in the mobile terminal such as the mobile phone QQ Landlord, the mobile phone micro-blog, or the mobile phone QQ space.

In block 706, an automatic voice of the telephone call server prompts the user.

In the present block, the telephone call server prompts the user using the automatic voice, e.g., “your authentication code needs to be checked, please enter the following content consecutively—the user account coupled with an asterisk key, and the specific password with four numbers, please input—”.

In block 707, the user A inputs, through the telephone, the number content of 1313113*1234.

In block 708, according to the information inputted by the user A, i.e., 1313113, the telephone call server obtains the information about the specific password, i.e., 1234, from the application server.

In block 709, the telephone call server verifies the information inputted by the user A, performs the authentication, and reports a request to the application server when the authentication is passed.

In the present block, when determining that the user account and the specific password inputted by the user A meets the configuration, the telephone call server reports the request to the application server to request to terminate the automatic login of the user A whose user account is 1313113 through the mobile terminal.

The telephone call server has capabilities such as identifying the content inputted by the user, and determining (authenticating) the legitimacy of the content, i.e., the user account is strictly matched with the specific password.

In block 710, the application server receives the request, and terminates a service of automatic login of the user account “1313113” of user A through any one of the mobile terminals.

In the present block, according to the request reported by the telephone call server, the application server provides a service capability of terminating the user account of user A for automatically login through the mobile terminal. After receiving the instruction sent by the application server, the mobile terminal terminates the information about “the remembered password” which is stored in the mobile terminal by the user account 1313113 of user A, so that the user A could not automatically login the application server through the mobile terminal again.

The above are just several examples of the present invention, and are not used for limiting the protection scope of the present invention. Any modifications, equivalents, improvements, etc., made under the spirit and principle of the present invention, are all included in the protection scope of the present invention.

1. A system for invalidating a password remembered by an application associated with a mobile terminal, comprising a mobile terminal, an application server and a telephone call server, wherein
the mobile terminal is adapted to register to the application server through an installed application; store a configured user account and a configured registered password; configure authentication information used for invalidating the password remembered by the application associated with the mobile terminal; receive an instruction for invalidating the password remembered by the application associated with the mobile terminal sent from the application server to invalidate the password remembered by the associated application and corresponding to the user account carried in the instruction;
the application server is adapted to provide the application to the mobile terminal, wherein an option of the authentication information used for invalidating the password remembered by the application associated with the mobile terminal is configured in the provided application; store the user account and the password of the application as well as the authentication information configured by a user through the mobile terminal and used for invalidating the password remembered by the application associated with the mobile terminal; receive a request for obtaining authentication information sent from the telephone call server; return to the telephone call server the authentication information corresponding to the user account carried in the request for obtaining authentication information; receive authentication success information sent from the telephone call server and output the instruction for invaliding the password remembered by the application associated with the mobile terminal to the mobile terminal; and
the telephone call server is adapted to receive an invalidation request sent from the user; transmit to the application server the request for obtaining authentication information according to the user account carried in the invalidation request; authenticate the user according to the returned authentication information; transmit to the application server the authentication success information after the authentication is passed.

2. The system according to claim 1, wherein the telephone call server comprises an Interactive Voice Response (IVR) or an Automatic Speech Recognition (ASR).

3. A system for invalidating a password remembered by an application associated with a mobile terminal, comprising a mobile terminal and an application server, wherein
the mobile terminal is adapted to register to the application server through an installed application; store a configured user account and a configured registered password; configure authentication information used for invalidating the password remembered by the application associated with the mobile terminal; receive an instruction for invalidating the password remembered by the application associated with the mobile terminal sent from the application server to invalidate the password remembered by the associated application and corresponding to the user account carried in the instruction; and
the application server is adapted to provide the application to the mobile terminal, wherein an option of the authentication information used for invalidating the password remembered by the application associated with the mobile terminal is configured in the provided application; store the user account and the password of the application as well as the authentication information configured by a user through the mobile terminal and used for invalidating the password remembered by the application associated with the mobile terminal; receive an invalidation request sent from the user; obtain the stored authentication information corresponding to the user account carried in the invalidation request to authenticate the user; and output the instruction for invaliding the password remembered by the application associated with the mobile terminal to the mobile terminal after the authentication is passed.

4. The system according to claim 3, wherein the application server comprises an application managing module, a registration managing module, a registration information storing module and an invalidation authenticating module, wherein
the application managing module is adapted to provide the application to the mobile terminal, wherein the option of the authentication information used for invalidating the password remembered by the application associated with the mobile terminal is configured in the provided application;
the registration managing module is adapted to interact with the mobile terminal; perform registration; after the user registers, output the user account and the password of the application as well as the authentication information configured by the user through the mobile terminal and used for invalidating the password remembered by the application associated with the mobile terminal to the registration information storing module;
the registration information storing module is adapted to store the received information; and
the invalidation authenticating module is adapted to receive the invalidation request sent from the user; obtain the authentication information corresponding to the user account carried in the invalidation request from authentication information stored in the registration information storing module to authenticate the user; and output the instruction for invalidating the password remembered by the application associated with the mobile terminal to the mobile terminal after the authentication is passed.

5. The system according to claim 3, wherein the user sends the invalidation request to the application server through another mobile terminal or a fixed telephone.

6. An application server, comprising an application managing module, a registration managing module, a registration information storing module and an invalidation authenticating module, wherein
the application managing module is adapted to provide an application to a mobile terminal, wherein an option of authentication information used for invalidating a password remembered by the application associated with the mobile terminal is configured in the provided application;
the registration management module is adapted to interact with the mobile terminal; perform registration; after the user registers, output a user account and the password of the application as well as the authentication information configured by a user through the mobile terminal and used for invalidating the password remembered by the application associated with the mobile terminal to the registration information storing module;
the registration information storing module is adapted to store the received information; and
the invalidation authenticating module is adapted to receive an invalidation request sent from the user; obtain the authentication information corresponding to the user account carried in the invalidation request from authentication information stored in the registration information storing module to authenticate the user; and output an instruction for invalidating the password remembered by the application associated with the mobile terminal to the mobile terminal after the authentication is passed.

7. A method for invalidating a password remembered by an application associated with a mobile terminal, comprising:
providing an corresponding application according to a download request of a mobile terminal, wherein an option of authentication information used for invalidating a password remembered by the application associated with the mobile terminal is configured in the provided application;
receiving a register request sent from the mobile terminal; storing authentication information configured by a user through the mobile terminal and used for invalidating the password remembered by the application associated with the mobile terminal; and
receiving an invalidation request sent from the user; obtaining the stored authentication information corresponding to a user account carried in the invalidation request to authenticate the user; and outputting an instruction for invalidating the password remembered by the application to the mobile terminal to cause the mobile terminal to invalidate the password remembered by the associated application and corresponding to the user account carried in the instruction after the authentication is passed.

8. The method according to claim 7, wherein the authentication information comprises information about the user account and an invalidation password.

9. The method according to claim 7, wherein the user sends the invalidation request to the application server through a fixed telephone.

10. The method according to claim 7, wherein the user sends the invalidation request to the application server through a short message.

11. The method according to claim 7, further comprising:
directly terminating a capability of the mobile terminal for logging in the associated application through the application after the authentication is passed; and
when the mobile terminal logs in the application through the user account and the password remembered by the application, outputting the instruction for invalidating the password remembered by the application associated with the mobile terminal to the mobile terminal.

12. The method according to claim 7, wherein in the instruction for invalidating the password remembered by the application associated with the mobile terminal outputted to the mobile terminal, the number of the application to be invalidated is one or more than one.

13. The system according to claim 4, wherein the user sends the invalidation request to the application server through another mobile terminal or a fixed telephone.
